(19) United States
(12) Patent Application Publication
(10) Pub. No.: US 2012/0183306 A1
(43) Pub. Date: Jul. 19, 2012

(54) OPTICAL TRANSMITTER INCLUDING EA MODULATOR AND DRIVER

(75) Inventor: Shingo INOUE, Yokohama-shi (JP)

(73) Assignee: SUMITOMO ELECTRIC INDUTRIES, LTD., Osaka (JP)

(21) Appl. No.: 13/348,685

(22) Filed: Jan. 12, 2012

(30) Foreign Application Priority Data
Jan. 18, 2011 (JP) 2011-008147

(51) Int. Cl. H04B 10/04

(52) U.S. Cl. 398/183

(57) ABSTRACT

An optical transmitter to drive the EA modulator integrated with an LD in a mode of lowered power consumption. The optical transmitter includes the optical device integrating the LD with the EA modulator, and the driver to modulate the EA modulator in the differential mode by being supplied with the modulation signal between the anode and the cathode common to the LD.

### BACKGROUND OF THE INVENTION

1. Field of the Invention

The present invention relates to an optical transmitter, in particular, an optical transmitter to driver a semiconductor optical device integrating a semiconductor laser diode (hereafter denoted as LD) with a semiconductor optical modulator of a type of the electro-absorption (hereafter denoted as EA) modulator.

2. Related Background Art

Recent optical communication system often applies a semiconductor optical device integrating an LD with an EA modulator to modulate light generated in the LD. An optical transmitter applied in such a system inevitably involves a semiconductor optical device with the LD and the EA modulator, and a driver circuit for driving both the LD and the EA modulator.

Various drivers for the EA modulator have been known. For instance, FIG. 7 shows a circuit diagram of a conventional driver circuit for the LD-EA modulator, which is disclosed in, for instance, the U.S. Pat. No. 5,706,117, the U.S. Pat. No. 6,044,067, and the U.S. Pat. No. 6,882,667. The transmitter 1X shown in FIG. 7 includes a semiconductor optical device 10 including the LD 11 and the EA modulator 12, where their cathodes are commonly connected to the constant voltage level, for instance, the positive power supply 7, while, the driver 20 is connected directly to the anode of the EA modulator 12 in the DC mode. The anode of the LD 11 receives the bias current from the current source 35, which is pulled up to the other power supply 6 for the LD 11.

FIG. 8 shows behaviors, a to c, of the nodes appeared in FIG. 7, where the behavior a shows the anode voltage of the LD 11, the behavior b shows the voltage of the common cathode of the LD 11 and the EA modulator 12, and the behavior c shows the voltage of the anode of the EA modulator 12. When the EA modulator 12 is directly driven by the driver 20 and a swing voltage of 2 Vp-p, 2.5V to 4.5V, necessary to be modulated the EA modulator 12, the power supply 7 for the driver 20 exceeds 5V and the power supply 6 for the LD is necessary to be higher than 6V. Such high voltages may be conventionally generated by DC-DC converters but make the power consumption of the DC-DC converters larger.

The driver circuit disclosed in the U.S. Pat. No. 6,882,667 gives a solution to solve the subject above described, that is, the LD 11 and the EA modulator 12 in the cathode thereof are commonly grounded, the anode of the LD 11 receives the bias current from the positive power supply 6 through the current source 35, and the anode of the EA modulator 12 is negatively biased by the bias circuit 36 through the inductor 33. Further, the driver 20, which has two outputs showing the differential mode and each pulled up to the power supply 7 for the driver 20, drives the EA modulator 12 by the AC mode through the capacitor 42.

FIG. 10 shows behaviors, a to c, of respective nodes in the optical transmitter 1Y shown in FIG. 9. As shown in FIG. 10, the arrangement shown in FIG. 9 may lower the voltage of the power supply 6 for the LD 11 to be 2V because the cathode of the LD 11 is grounded, while, the positive power supply 7 for the driver 20 may be lowered to 3.3 V because the output of the driver 20 couples with the EA modulator 12 in the AC mode. Accordingly, even the DC-DC converter generates such voltages for the power supplies, 6 and 7, the power consumption thereof may be reduced.

However, the arrangement shown in FIG. 9 is hard to reduce the power consumption of the transmitter further by various reasons. One is that the power supply 6 for the LD 11 is necessary to be higher than 2V to operate the current source 35 stably, and the other reason is that at least 2 Vp-p for the modulation signal applied to the EA modulator 12 is necessary to attain the substantial extinction ratio of the light emitted from the EA modulator 12 and the power supply 7 for the driver 20 is necessary to be higher than 3.3 V to get such large swing voltage in the driver 20.

### SUMMARY OF THE INVENTION

An aspect of the present invention relates to an optical transmitter comprising a semiconductor optical device and a driver to drive the semiconductor optical device. The semiconductor optical device integrates the LD with the EA modulator on a single semiconductor substrate by an arrangement where the back surface of the substrate provides a cathode electrode common to the LD and the

EA modulator. The driver has the differential arrangement with two outputs complementary to each other to drive the EA modulator in the differential mode. One of the outputs is coupled with the anode of the EA modulator though a capacitor, while, the other outputs is coupled with the common cathode of the EA modulator through another capacitor.

In the arrangement of the optical transmitter, the anode of the LD may be positively biased, while, the anode of the EA modulator may be negatively biased each through an inductor. Because the EA modulator may be driven in the differential mode, the amplitude of the modulation signal output from the outputs of the driver may be half of the conventional arrangement of the single phase driving. Moreover, because the LD and the EA modulator may be oppositely biased with respect to the common cathode, the power supply for the LD and that for the driver may lower the voltage thereof, which may make the conventional active device, namely, the silicon based device such as Si-CMOS, SiGe HBT, and so on, may be usable in the driver instead of the compound semiconductor based active device, which may reduce the cost of the optical transmitter.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows a circuit diagram of an optical transmitter according to the first embodiment of the present invention;

FIG. 2A shows signal shapes where the behavior a is measured at the anode of the LD, the behavior b is measured at the cathode common to the LD and the EA modulator, and the behavior c is measured at the anode of the EA modulator; and FIG. 23 shows signal shapes shown in FIG. 2A but relatively measured from the common cathode;

FIG. 3 shows a circuit diagram of another optical transmitter according to the second embodiment of the present invention;

FIG. 4A shows signal shapes appeared in the optical transmitter of FIG. 3, where the behavior a is measure at the anode of the LD, the behavior b is measured at the common cathode, and the behavior c is measure at the anode of the EA modulator c; and FIG. 4B shows signal shapes shown in FIG. 4A but relatively measured from the common cathode;

FIG. 5 shows a circuit diagram of still another optical transmitter according to the third embodiment of the present invention;

FIG. 6A shows signal shapes where the behavior a is measured at the anode of the LD, the behavior b is measured at the common cathode, and the behavior c is measured at the anode of the EA modulator; and

FIG. 6B shows signal shapes shows in FIG. 6A but relatively measured from the common cathode;

FIG. 7 is a circuit diagram of a conventional optical transmitter;

FIG. 8 shows signal shapes where the behavior a is measured at the anode of the LD, the behavior b is measured at the cathode of the EA modulator, and the behavior c is measured at the anode of the EA modulator;

FIG. 9 is a circuit diagram of another conventional optical transmitter; and

FIG. 10 shows signal shapes measured at the anode of the LD, a, at the common cathode, b, and the anode of the EA modulator, c.

### DESCRIPTION OF PREFERRED EMBODIMENTS

Next, some preferred embodiments according to the present invention will be described as referring to accompany drawings. In the description of the drawings, the same numerals or symbols will refer to the same elements without overlapping explanations.

### First Embodiment

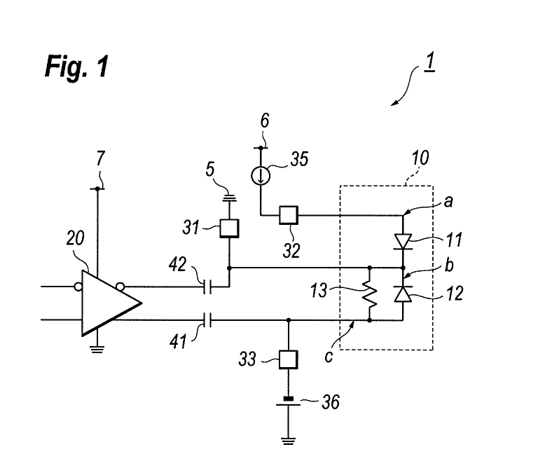

FIG. 1 is a circuit diagram of an optical transmitter 1 according to the first embodiment of the invention. The optical transmitter 1 includes a semiconductor optical device 10 and a driver 20 to drive the semiconductor optical device 10. The semiconductor optical device integrates the LD 11 with the EA modulator 12. The LD 11 generates laser light by being supplied with a bias current from a current source 35. The EA modulator 12 modulates the laser light to generate the modulated light by being driven by the modulating signal supplied from the driver 20.

The semiconductor optical device 10 may integrate the LD 11 with the EA modulator 12 on the single semiconductor substrate. The bottom surface of the semiconductor substrate provides a cathode common to the LD 11 and the EA modulator 12, and this common cathode is grounded through the inductor 31. The LD 11 and the EA modulator 12 are oppositely biased with respect to the ground 5. That is, the anode of the LD 11 is coupled with the positive power supply 6 through a series circuit of the current source 35 and the inductor 32 to receive the bias current. While, the anode of the EA modulator 12 is negatively biased by the power supply 36 through the inductor 33. A termination resistor 13 for the driver 20 is connected between the anode and cathode of the EA modulator 12 in the optical device 10.

The driver 20 may drive the EA modulator 12. The driver 20 may have an arrangement of the differential circuit to drive the EA modulator 12 in the differential mode. Specifically, one of outputs of the driver 20 is coupled with the anode of the EA modulator 12 through the capacitor 41 as the first capacitor, while, the other output of the driver 20 is coupled with the cathode of the EA modulator 12 through the other capacitor 42 as the second capacitor. Thus, the EA modulator 12 may be driven in the differential mode.

The optical transmitter 1 shown in FIG. 1 may lower the positive power supply to about 2V because the LD 11 and the EA modulator 12 may be oppositely biased with respect to the ground 5, and the

EA modulator 12 is driven in the AC mode. Moreover, the power supply 7 for the driver 20 may be lowered to 3.3V because the driver 20 couples with the EA modulator 12 in the AC mode . Thus, the DC-DC converter, which is not explicitly shown in FIG. 1, may reduce the power consumption thereof.

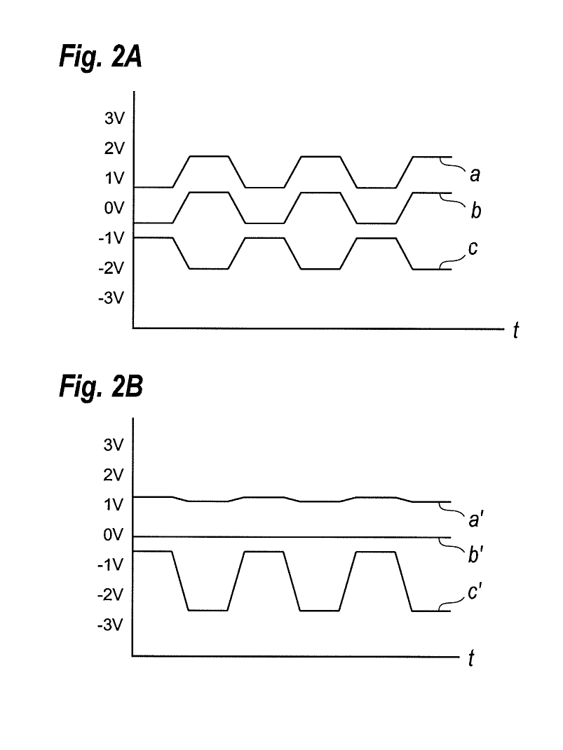

Moreover, the driver 20 shown in FIG. 1 may drive the EA modulator 12 in the differential mode, which may set the swing voltage of the respective outputs of the driver 20 in a half of the conventional arrangement, which may further reduce the power consumption of the optical transmitter 1. FIG. 2 specifically explains the mechanism to reduce the power consumption of the transmitter 1.

FIG. 2A shows behaviors of respective nodes, a to c, appeared in FIG. 1, where the behavior a shows the signal shape of the anode of the LD 11, the behavior b shows the signal shape of the common cathode, and the behavior c corresponds to the signal shape of the anode of the EA modulator 12. FIG. 2B also shows relative behaviors, a′ to c′, of respective nodes measured from the behavior b. Because the driver 20 differentially drives the EA modulator 12, the amplitude of the signal of the anode of the LD 11 shown by the behavior a is set about 1 Vp-p, which is half of those necessary in the conventional arrangement.

In the conventional optical transmitter, active devices made of GaAs, InP, and so on are necessary to obtain such large signals at high frequencies. However, active devices made of such compound semiconductor materials generally show cost ineffective. The arrangement of the differential driving according to the present embodiment makes the implementation of silicon-based devices, such as Si, SiGe and so on, possible to reduce the cost of the optical transmitter.

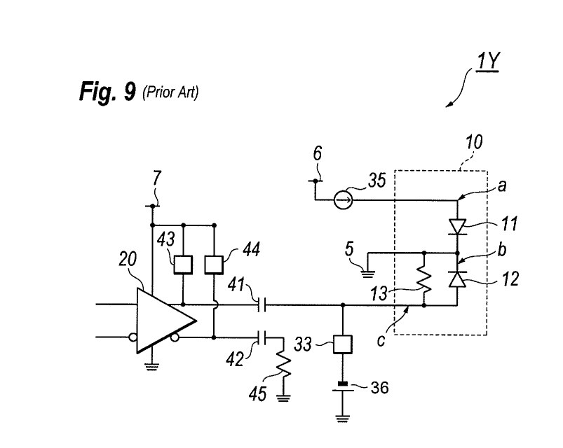

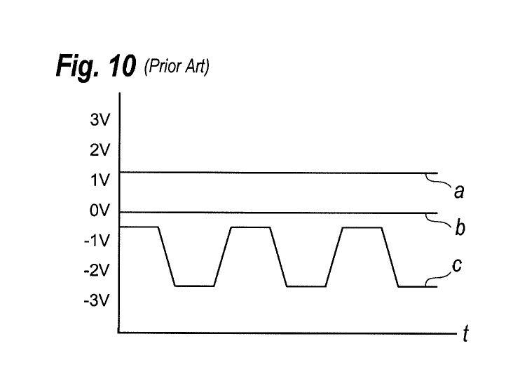

The differential arrangement of the driver 20 may also omit the pull-up elements, 43 and 44, shown in FIG. 9 because the output amplitude of the driver 20 may be reduced to a half of those in the conventional arrangement. Or, even when the pull-up elements, 43 and 44, are provided, the positive power supply 7 for the driver 20 may be lowered to less than 3.3V, for instance, 2.5V or 1.8V, which may result in not only further reduction of the power consumption but may introduce the application of silicon based devices, for instance, CMOS, SiGe HBT (Hetero-junction Bipolar Transistor), which may further reduce the cost.

### Second Embodiment

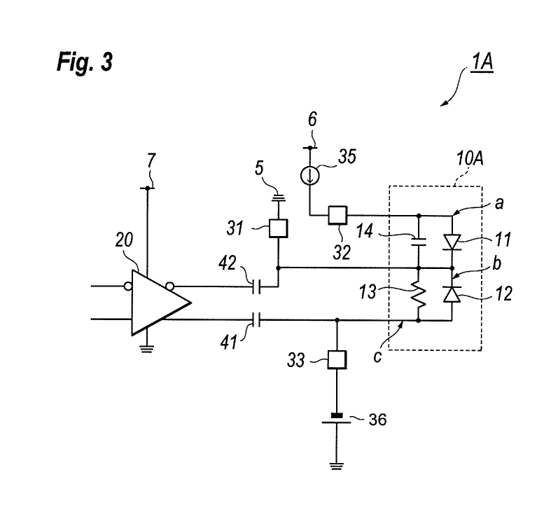

FIG. 3 is a circuit diagram of another optical transmitter according to the second embodiment of the present invention. The optical transmitter 1A shown in FIG. 3 has the optical device 10A instead of the optical device 10 of the aforementioned embodiment shown in FIG. 1. Other arrangements of the optical device 10A are substantially same with those provided in the optical device 10 of the first embodiment.

The optical device 10A further provides a capacitor 14 as the third capacitor between the anode and cathode of the LD 11 in addition to the arrangement of the optical device 10. The optical transmitter 1A of the second embodiment has advantages substantially same with those of the first embodiment. Moreover, the optical transmitter 1A of the present embodiment may bypass high frequency components leaked from the modulation signal applied to the EA modulator 12 from the driver 20, which may suppress the LD 11 from being modulated by the modulation signal leaked through the cathode common to the LD 11 and the EA modulator 12. Thus, the degradation of the transmission quality of the optical transmitter 1A may be prevented.

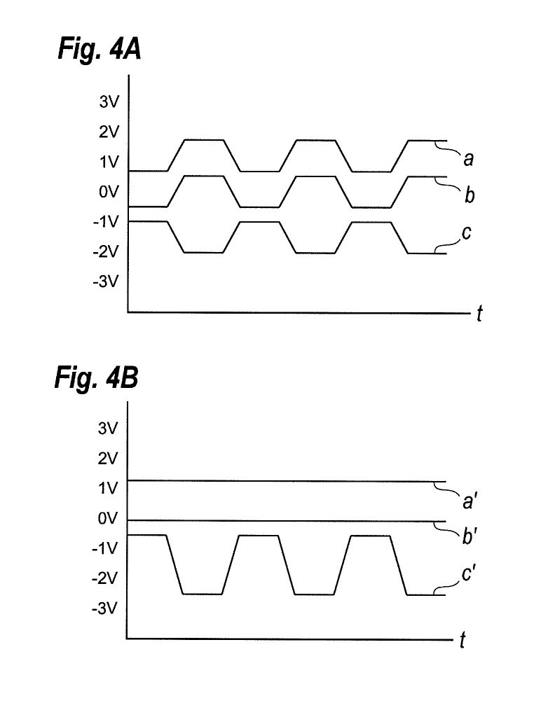

The mechanism to suppress the degradation of the transmission quality described above is further explained as referring to FIGS. 2 and 4. FIG. 4A shows behaviors, a to c, of respective nodes shown in FIG. 3. As already described, the behavior a corresponds to the anode of the LD 11, the behavior b corresponds to the common cathode, and the behavior c shows the anode of the EA modulator 12. FIG. 4B rewrites behaviors, a′ to c′, shown in FIG. 4A relative to the behavior b.

Referring to FIG. 2B, the optical transmitter 1 has a possibility to modulate the LD 11 directly because the EA modulator 12 is driven by the driver 12 in the differential mode, which means that the common cathode b is driven through the capacitor 42. Thus, the bias applied to the LD 11 swings by the voltage whose amplitude is a′-b′.

On the other hand, the capacitor 14 connected between the anode and the cathode of the LD 11 may operate as a bypassing capacitor for the LD 11 which may suppress the LD 11 from being modulated by the modulation signal. In this arrangement, the amplitude of the modulation signal applied to the EA modulator 12 becomes half of those of the conventional arrangement, namely, about 1 Vp-p.

### Third Embodiment

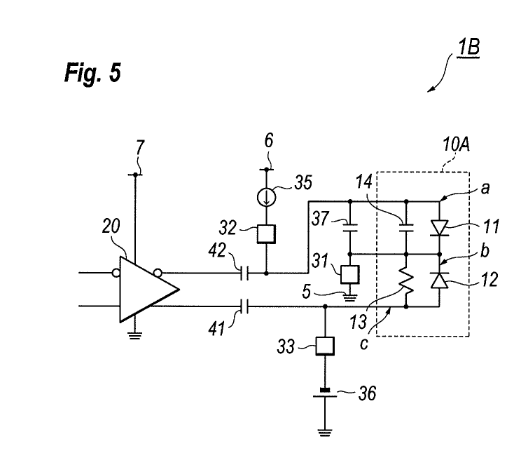

FIG. 5 shows a circuit diagram of the optical transmitter 1B according to the third embodiment of the present invention. The optical transmitter 1B shown in FIG. 5 has an arrangement in the connection between the optical device 1A and the driver 20, which is distinguishable from the arrangement of the former embodiment shown in FIG. 3. That is, one of the outputs of the driver 20 is coupled with the anode of the EA modulator 12 as those of the aforementioned embodiments but the other outputs of the driver 20 is coupled with the anode of the LD 11 through the capacitor 42 not the common cathode of the LD 11 and the EA modulator.

The common cathode of the LD 11 and the EA modulator is coupled with the anode of the LD 11 through a capacitor 37 as the fourth capacitor with large capacitance and grounded through the inductor 31. That is, the capacitor 37 may be regarded as a short circuit for high frequencies and one of the output signals of the driver 20 is provided to the common cathode of the LD 11 and the EA modulator 12 through the capacitor 42 and the other capacitor 37. Other arrangements are substantially same with those of the optical transmitted 1A of the former embodiment.

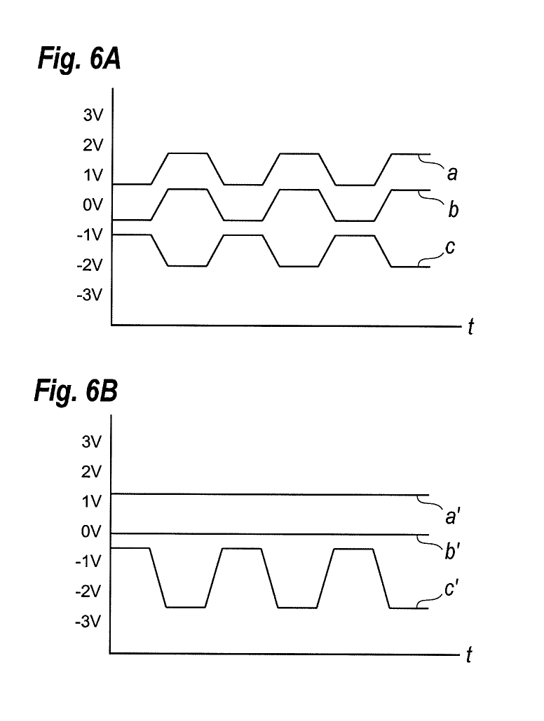

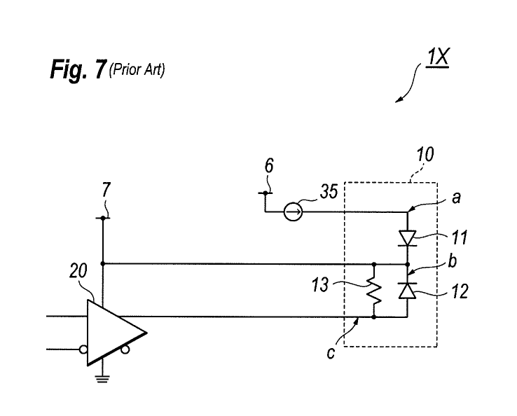

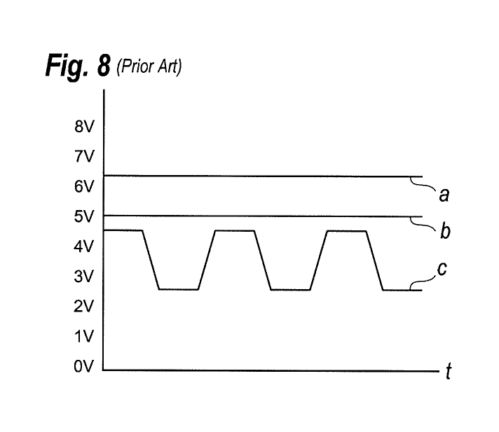

FIG. 6A shows behaviors, a to c, of respective nodes; while, FIG. 6B rewrites behaviors, a to c, of respective nodes to behaviors, a′ to c′, which are relatively measured from the behavior b.

The optical transmitter 1B drives the EA modulator 12 in the differential mode by the driver 20, which may make the amplitude of the modulation signal in half of those provided in the conventional arrangement where the EA modulator 12 is driven by the single phase signal. The optical transmitter 1B may lower the positive power supply for the driver 20, which may not only reduce the power consumption of the driver 20 but also widen a type of active devices for the driver 20 to Si, SiGe and so on.

The optical device 10B also provides the capacitor 14 connected in parallel to the LD 11 within the optical device 10A to bypass the modulation signal, which may suppress the degradation of the transmission quality of the optical transmitter 1B.

Because the optical transmitter 1B applies one of the modulation signal directly to the anode of the LD 11, which may possibly drive the LD 11 in the AC mode. However, the capacitor 37 with the large capacitance may bypass the modulation signal and operate the LD 11 in substantially DC mode.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

I claim:

1. An optical transmitter, comprising:
a semiconductor optical device integrating a semiconductor laser diode with a semiconductor optical modulator of an electro-absorption type to modulate light generated in the laser diode, the semiconductor laser diode having an anode and a cathode, the semiconductor optical modulator having an anode and a cathode common to the cathode of the semiconductor laser diode; and
a driver having two outputs complementary to each other to drive the semiconductor optical modulator in a differential mode, one of the outputs being coupled with an anode of the semiconductor optical modulator though a first capacitor, the other outputs being coupled with a cathode of the semiconductor optical modulator through a second capacitor.

2. The optical transmitter of claim 1,
wherein the anode of the semiconductor laser diode is positively biased and the anode of the semiconductor optical modulator is negatively biased.

3. The optical transmitter of claim 2,
wherein the cathode common to the semiconductor laser diode and the semiconductor optical modulator is grounded in a DC mode through an inductor.

4. The optical transmitter of claim 1,
wherein the semiconductor optical device further includes a third capacitor connected between the anode and the cathode of the semiconductor laser diode.

5. The optical transmitter of claim 1,
wherein the cathode common to the semiconductor laser diode and the semiconductor optical modulator receives the other of outputs of the driver through a fourth capacitor provided in an outside of the semiconductor optical device and the second capacitor,
wherein the other outputs of the driver is coupled with the anode of the semiconductor laser diode through the second capacitor.

6. The optical transmitter of claim 5,
wherein the semiconductor optical device further includes a third capacitor connected between the anode and the cathode of the semiconductor laser diode, the second capacitor being provided within the semiconductor optical device, and
wherein the fourth capacitor has capacitance greater than capacitance of the other capacitor.

7. The optical transmitter of claim 1,
wherein the anode of the semiconductor laser diode is coupled with a positive power supply through a series circuit of a current source and an inductor to receive a bias current.

8. The optical transmitter of claim 7,
wherein the driver is provided with another power supply whose voltage is less than a voltage of the positive power supply to the semiconductor laser diode.
